(19) United States
(12) Patent Application Publication
(10) Pub. No.: US 2005/0155066 A1
(43) Pub. Date: Jul. 14, 2005

(54) Reserved video recording method using internet data

(75) Inventor: Cheol Sheong Lee, Suwon (KR)

Correspondence Address: FLESHNER & KIM, LLP, P.O. Box 221200, Chantilly, VA, 20153-1200, US

(73) Assignee: LG Electronics Inc.

(21) Appl. No.: 11/048,890

(22) Filed: Feb. 3, 2005

Related U.S. Application Data
(62) Division of application No. 09/477,675, filed on Jan. 5, 2000.

(30) Foreign Application Priority Data
Jan. 26, 1999 (KR) 2434/1999
Nov. 23, 1999 (KR) 52033/1999

(51) Int. Cl. H04N 5/445; G06F 3/00; H04N 7/00; H04N 5/91; G06F 13/00

(52) U.S. Cl. 725/58; 386/46

(57) ABSTRACT

The present invention relates to a reserved video recording apparatus using internet data which includes a modem for connecting to an external communication network to thereby transmit and receive data, a video memory which has a memory space corresponding to a pixel of a video text, a RAM DAC for continuously scanning the data stored in the video memory and converting each data thusly scanned to RGB signals, an NTSC encoder for converting the RGB signals outputted from the RAM DAC to NTSC signals for broadcasting, a monitor and a TV for outputting the signals outputted from the RAM DAC and the broadcast signals outputted from the NTSC encoder on the screen, respectively, a memory for temporally storing the broadcast schedule data of the selected program, a micro computer for controlling the operation of a recorder to which an external video signal passed through a tuner and a Y/C unit is finally inputted based on the broadcast schedule data temporally stored and a timer. Thus, a reserved video recording can be implemented in an user-friendly environment with the increase of internet users by connecting to a homepage of a broadcasting station for selecting a broadcast program and its schedule data and performing a reserved video recording based on the data.

### BACKGROUND OF THE INVENTION

1. Field of the Invention

The present invention relates to a reserved video recording apparatus and method using internet data and, in particular, to a reserved video recording apparatus using internet data which makes it possible to connect to a homepage of each broadcasting station or web sites which provide broadcast program schedule data via the internet for thereby selecting a program desired to be video recorded, storing the schedule data of the selected program, and recording the corresponding program based on the stored data at the start of the program.

2. Description of the Prior Art

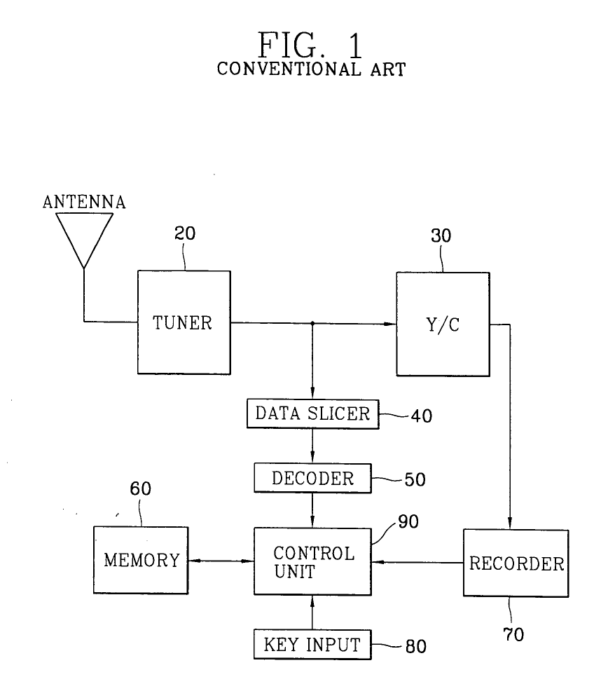

As shown in FIG. 1, a conventional reserved video recording apparatus includes: a tuner 20 for selecting a desired broadcast signal among broadcast signals received from an antenna; a Y/C signal processing unit 30 in which video signals outputted from the tuner 20 process luminance signals and chrominance signals; a data slicer 40 in which the video signals outputted from the tuner 20 detects a certain horizontal line designated in a vertical retrace line interval of the video signals to thereafter output the same; a decoder 50 for detecting broadcast program data among data detected by the data slicer 40; a recorder 70 for recording the signals processed by the Y/C signal processing unit; a key input unit 80 for transmitting all sorts of orders inputted by an user; a control unit 90 for unit 80 and the decoder 50; and a memory 60 for storing the detected broadcast schedule data in accordance with the control of the control unit 90.

A reserved video recording process according to the conventional reserved video recording apparatus constructed as described above will be described as follows with reference to FIG. 1.

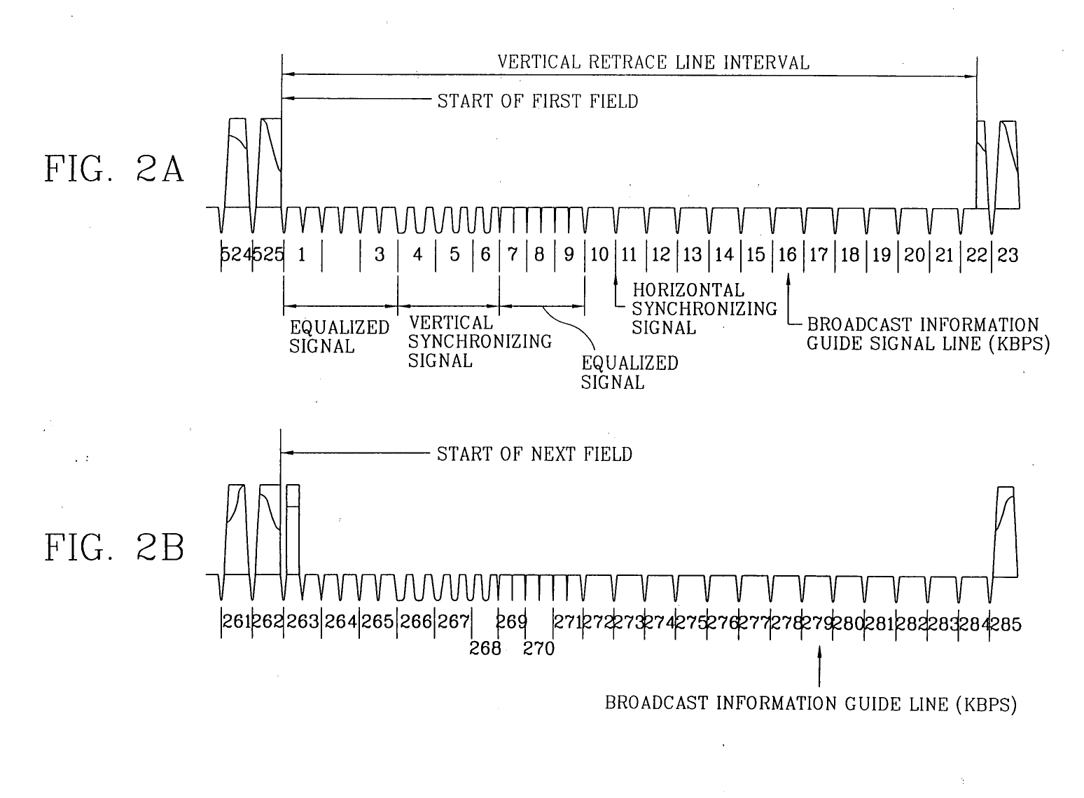

First, a certain particular horizontal line in a vertical retrace line interval of video signals tuned and outputted by the tuner 20 is detected by the data slicer 40. In presently transmitted video signals, there is a vertical retrace line interval, as illustrated in FIG. 2, as well as an audible and visible video signal interval Therefore, a certain particular line (the 16th line under the current KBPS standard) among horizontal lines positioned in the vertical retrace line interval is selected by the data slicer 40.

The broadcast schedule data contained in the horizontal line is detected by the decoder 50 for thereby being transmitted to the control unit 90. The control unit 90 reformats the data detected by the decoder 50 in a certain format (e.g., in a table format) and stores the reformatted data in the memory 40. Next, when an user selects a key for displaying the broadcast schedule data on the screen using the key input unit 80, the control unit 90 displays a broadcast schedule table of a certain format stored in the memory 60 on the screen.

Based on the thusly displayed broadcast schedule table, when the user selects a program that he or she intends to reservedly video record using the key input unit 80, the control unit 90 readouts the identification code of the corresponding program stored in the memory 60, and controls the tuner 20 for thereby tuning in to a reserved channel, so that demodulated video signals are outputted. The thusly demodulated video signals are inputted to the Y/C signal processing unit 30 and the data slicer 40, respectively. The data slicer 40 detects a certain particular horizontal line as described above, and the decoder 50 extracts the broadcast program data contained in the signal of the horizontal line to thereafter transmit the same to the control unit 90.

The control unit 90 compares the presently on-the-air program code (On-Air ID) with the program identification code readout from the memory 60. As a result of comparison, if the both codes are identical, the recorder 70 is controlled to thus record the video signals processed by the Y/C signal processing unit 30. If the both codes become different during the recording, the recorder 70 is controlled for thereby finishing the recording. However, the conventional reserved video recording apparatus thusly operated has problems that there are not many products which adopt the KBPS standard, the above-described apparatuses are so expensive that the product price is increased, the reserved video recording process is very complicated, and a reserved video recording using the internet is impossible.

### SUMMARY OF THE INVENTION

Accordingly, it is an object of the present invention to provide a reserved video recording apparatus using internet data by which a reserved video recording can be performed easily and at a lower cost.

To achieve the above objects, in a video recording/playback apparatus, there is provided a reserved video recording apparatus using internet data according to the present invention which includes: a communication unit for connecting to a communication network to thereafter transmit and receive data; a video memory unit for memorizing pixels of a video text; a conversion unit for converting data received by the communication unit to signals for outputting the data on the screen of an external video display device; a storage unit for storing an selected broadcast program and its broadcast schedule data which correspond to the output screen; and a control unit for executing a reserved video recording of the corresponding program according to the stored data.

Additional advantages, objects and features of the invention will become more apparent from the description which follows.

### BRIEF DESCRIPTION OF THE INVENTION

The present invention will become more fully understood from the detailed description given hereinbelow and the accompanying drawings which are given by way of illustration only, and thus are not limitative of the present invention, and wherein:

FIG. 1 is a block diagram of a reserved video recording apparatus according to the conventional art;

FIG. 2(a) is a view illustrating an odd field signal waveform during a vertical retrace line interval of a composite video signal;

FIG. 2(b) a view illustrating an even field signal waveform during a vertical retrace line period of a composite video signal;

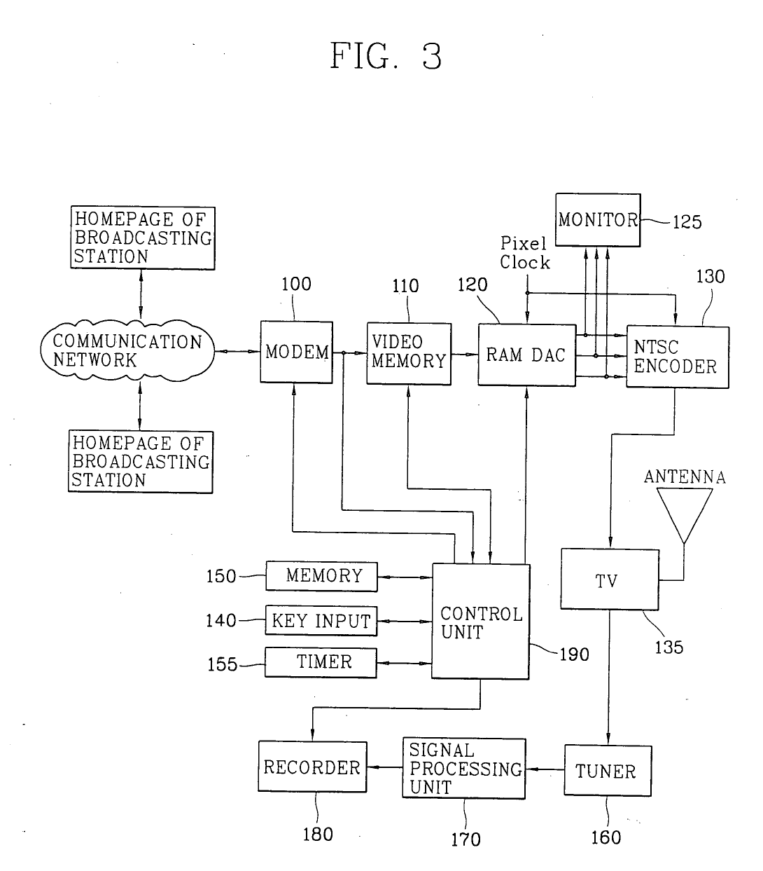

FIG. 3 is an embodiment of a reserved video recording apparatus according to the present invention.

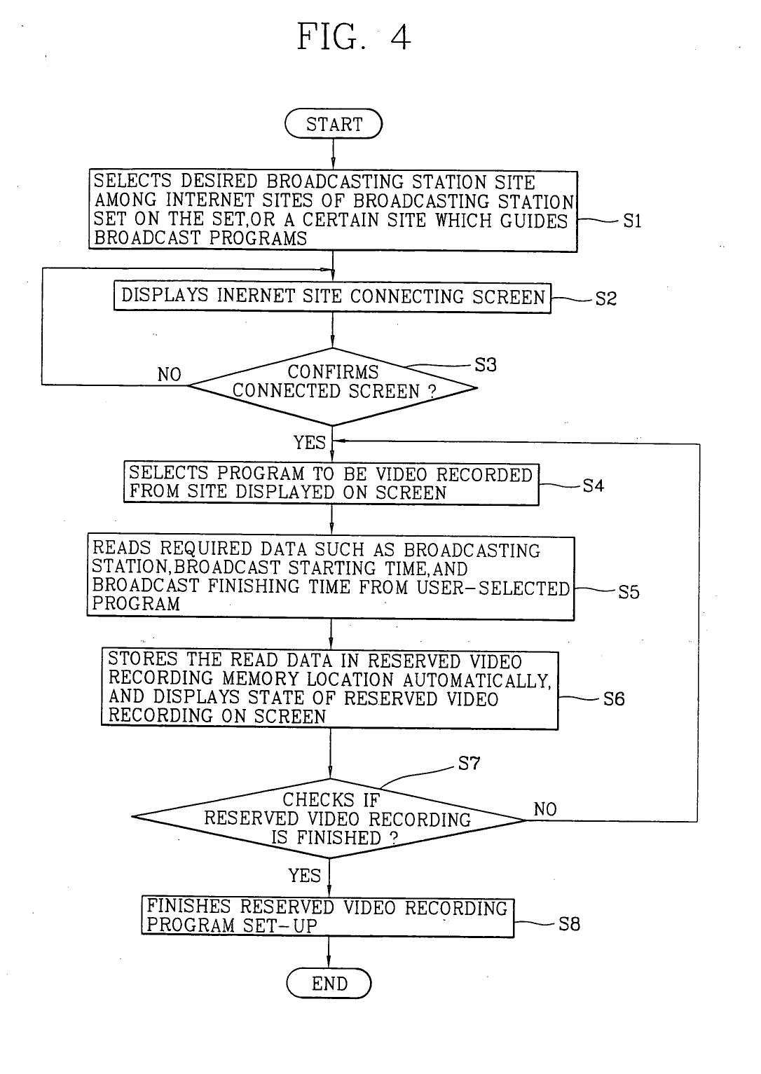

FIG. 4 is a first embodiment of a reserved video recording set-up method according to the present invention.

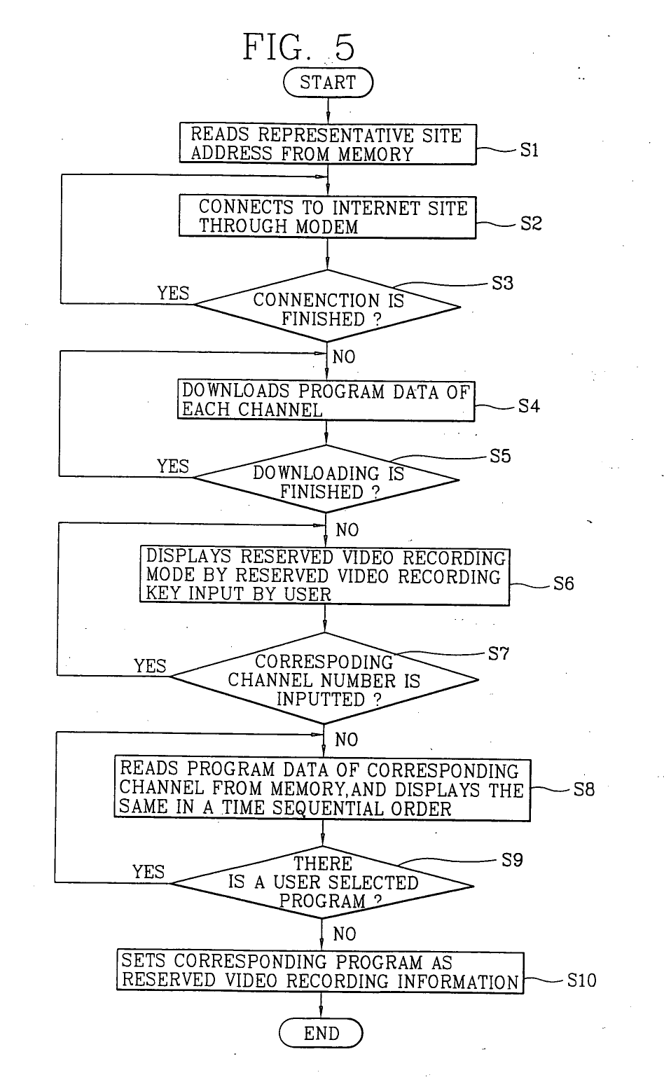

FIG. 5 is a second embodiment of a reserved video recording set-up method according to the present invention.

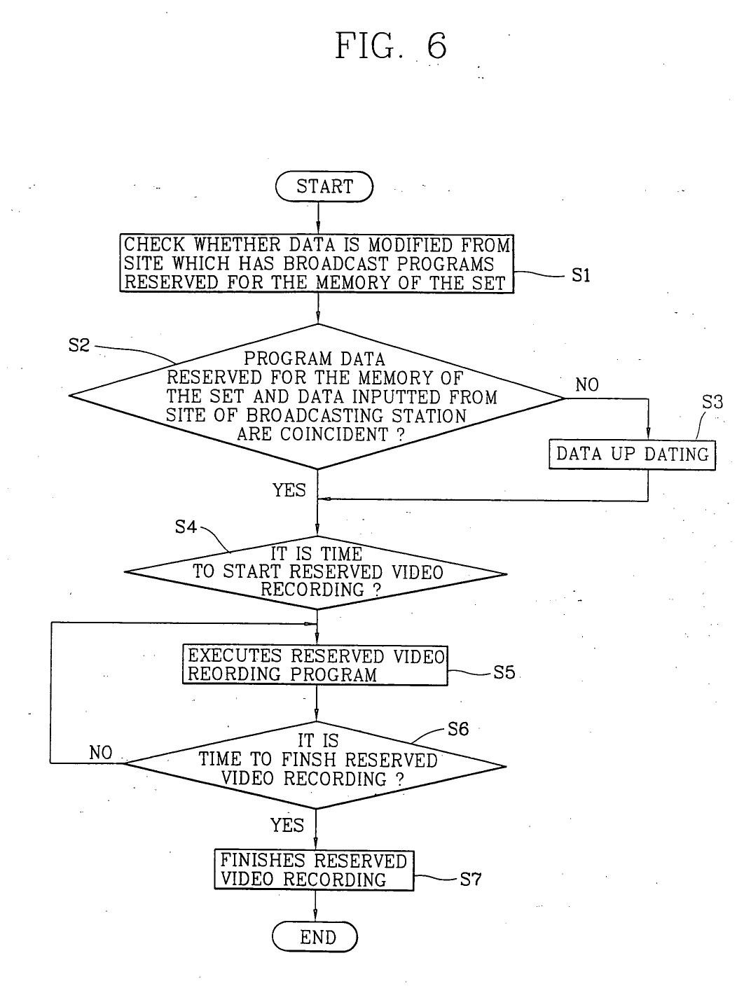

FIG. 6 is an embodiment of a reserved video recording execution method according to the present invention.

### DETAILED DESCRIPTION OF THE PREFERRED EMBODIMENTS

A reserved video recording apparatus using internet data according to the present invention will be described below with reference to FIG. 3.

FIG. 3 illustrates an embodiment of a reserved video recording apparatus using internet data according to the present invention which includes a modem 100 for connecting to an external communication network to thereby transmit and receive data, a video memory 110 which is connected with the modem 100 for thereby memorizing a video signal in a memory space corresponding to a pixel of a video text, a RAM DAC (Random Access Memory Digital/Analog Converter) 120 for continuously scanning the data stored in the video memory 110 and converting each data thusly scanned to RGB signals, a monitor 125 for outputting the signals outputted from the RAM DAC 120 on the monitor screen, an NTSC encoder 130 for converting the RGB signals outputted from the RAM DAC 120 to NTSC signals, a TV 135 for outputting the signals outputted from the NTSC encoder 130 on the TV screen, a key input unit 140 for selecting a broadcast program and all sorts of functions such as reserved video recording, a memory 150 for storing the broadcast schedule data of a broadcast program, a tuner 160 which is placed in a VCR and selects a RF signal transmitted from a broadcasting station, a Y/C signal processing unit 170 for separating a composite video signal outputted from the tuner 160 into a luminance signal and a chrominance signal, a control unit 190 which is connected with the modem 100, video memory 110, RAM DAC 120, memory 150, key input unit 140, and timer 155 for thereby controlling all sorts of functions, and a recorder 180 for recording the video signal outputted from the Y/C signal processing unit in accordance with the control of the control unit 190.

The operational sequence for the reserved video recording apparatus using internet data according to the present invention constructed as described above will be described below in detail.

When an user selects the reserved video recording mode using the key input unit 140, the control unit 190 readouts the broadcast program data pre-stored in the memory 150, and outputs the same onto the screen of the TV 135 or the monitor 125. Then, the user selects a desired broadcast program using a certain key of the key input unit 140 based on the displayed data. Next, when a broadcast program selection order is inputted, the control unit 190 stores the channel information of a selected broadcast program in the memory 150, while executing a web browser using the modem 100, connecting to a server (not shown) which provides an internet service, and then inputting a position information of the selected broadcasting station, for example, the IP address, into the web browser, thus trying to connect to the homepage of the corresponding broadcasting station. The control unit 190 checks using the modem 100 whether a connection to the internet service provider server is made or not. If the connection is not made, the connection trial is repeated until it succeeds.

When a connection to the homepage of the broadcasting station is made, data provided by the site is transmitted to the modem 100 through a communication network. The control unit 190 analyzes the digital data received from the modem 100 to thereby find out the format of the data and a relative position in a page of the data. According to the results of the analysis, each received data is converted to a pixel data based on the output resolution and the number of colors presently set for the apparatus. Then, the control unit 190 writes the pixel data in the memory 110 by designating a memory address corresponding to a position which will be displayed on the screen.

Meanwhile, the RAM DAC 120 converts each pixel data in an address of the video memory 110 to the corresponding RGB signal, while continuously scanning the video memory 110. The converted signal is synchronized with a pixel clock which is a synchronous clock to display signals on the screen to thereafter be outputted to the NTSC encoder 130 and the monitor 125. The above-mentioned RGB signal is a signal which can be displayed in an image right after it is applied to an external display apparatus such as a monitor.

Based on the display information above described, the user continuously selects related links such as hypertext links for thereby arriving at sites which provides the schedule data of the desired broadcast program.

The RGB signals outputted from the RAM DAC 120 are inputted to the NTSC encoder 130 to thus be converted to NTSC signals. Horizontal synchronizing signals and vertical synchronizing signals which are synchronized with the pixel clock are inserted into the NTSC video signals, and applied to the TV 135 for thereby being displayed in an image. Also, in the case that the signals are applied to the monitor 125, the same result is obtained. Of course, it is possible to selects between the monitor 125 and the TV 135.

Next, when the user selects a program that he or she intends to reservedly video record and its broadcast schedule data (date and time) based on the display screen outputted to the monitor 125 or the TV 135, and chooses to reservedly video record the program, the control unit 190 stores the information in the memory 150 in which the channel information is pre-stored. At this time, the user may selects a plurality of programs, in which case, broadcast schedule data is stored by each program so that the programs can be distinguished from each other.

When the user finishes the operation of recording reservation, the control unit 190 traces the present time continuously using the timer 155, while reading out the broadcast program and its schedule data stored in the memory 150. When the control unit 190 confirms that both time data are identical, the recorder 180 is controlled at that time for thereby recording inputted broadcast signals.

In the embodiment above described, the connection to an external internet network is made using the modem, while it is also possible to make a connection using an extra independent apparatus such as an internet set-top box, etc. FIG. 4 is a first embodiment of a reserved video recording set-up method according to the present invention, and the detailed description thereof is as follows.

First, the user selects a desired broadcasting station site among the internet sites of broadcasting stations set for the set as a key svc such as the reserved video recording mode/channel selection, or a certain site which guides broadcast programs S1. At this time, it is assumed that a channel table corresponding to each region is pre-stored. Then, an internet site connecting screen is displayed S2, the connected screen is confirmed S3, and a program to be video recorded is selected from a site displayed on the screen by an up/down key or enter key S4. If the connected screen is not confirmed, the routine returns back to S2 to thereafter read required data such as the broadcasting station, broadcast starting time, and broadcast finishing time from the user-selected program S5. Herein, only the finishing time data of each broadcast data is downloaded by presetting the station in a way of channel memory. Again, the read data (the broadcasting station, starting time, and finishing time) above mentioned is automatically stored in a reserved video recording memory location, and the state of the reserved video recording is displayed on the screen S6. Thereafter, it is determined whether there is a key input for checking if the reserved video recording is finished S7. If there is a key input, the routine returns to S4, and if there is not a key input, the reserved video recording program set-up is finished S8.

FIG. 5 is a second embodiment of a reserved video recording set-up method according to the present invention, and the detailed description thereof is as follows.

First, a representative site address is read from the memory S1. At this time, the representative site stored in the memory is a connection site by region designated by the user in advance. Next, a connection to an internet site is made through the modem S2, and it is checked whether the connection is finished or not S3. If the connection is finished, program data of each channel is downloaded S4. If not finished, the routine returns to S2. At this time, firstly, selected channel's programs for 2˜3 days since the present time which are set for the set are downloaded, and then programs for next 4˜7 days are downloaded. Next, it is checked whether the downloading is finished S5. If the downloading is finished, the reserved video recording mode is displayed by a reserved video recording key input by the user S6. If not finished, the routine returns to S4. It is determined whether the corresponding channel number is inputted S7. If there is a key input, program data of the corresponding channel is read from the memory, and displayed in a time sequential order S8. If not, the routine returns to S8. It is checked whether there is an user-selected program S9. If there is an user-selected program, the corresponding program is set as a reserved video recording information S10 to thereafter be finished. If not, the routine returns to S8.

FIG. 6 is an embodiment of a reserved video recording execution method according to the present invention, and the detailed description thereof is as follows.

First, it is checked whether data is modified from the site which has the broadcast programs reserved for the memory of the set S1. Again, the program data reserved for the memory of the set is compared with the data inputted from the site of the broadcasting station S2. If both data are not coincident S3, the program data is updated S4. If both data are coincident, it is determined if it is time to start a reserved video recording S4. If it is time to start a reserved video recording, a reserved video recording program is executed S5. If not, the routine returns back to S2, and it is determined if it is time to finish the reserved video recording S6. If it is time to finish the reserved video recording, the reserved video recording is finished S7. If not, the routine returns to S5.

As described above, the reserved video recording apparatus using internet data according to the present invention provides effects that a reserved video recording can be implemented in an user-friendly environment with the increase of internet users by connecting to a homepage of a broadcasting station for selecting a broadcast program and its schedule data and performing a reserved video recording based on the data.

1-7. (canceled)

8. A video signal reserved video recording set-up method, comprising:
a first step of selecting a desired broadcasting station site among the internet sites of broadcasting stations set for the set;
a second step of displaying an internet site connecting screen and confirming the connected screen;
a third step of selecting a program to be reservedly video recorded from the site displayed on the screen;
a fourth step of reading required data such as the broadcasting station, broadcast starting time, and broadcast finishing time from the user-selected program;
a fifth step of automatically storing the data read in the fourth step in a reserved video recording memory location and displaying the state of the reserved video recording on the screen;
a sixth step of determining whether there is a key input for checking if a reserved video recording is finished and finishing the reserved video recording set-up.

9. (canceled)

10. The method of claim 8, wherein the fourth step of reading the data includes receiving the data from the internet onto a terminal.

11. A video recording method comprising:
displaying an internet connecting screen;
selecting a program to be video recorded from a site displayed on the screen;
reading data relating to the selected program;
storing the read data; and
determine if reserved video recording is finished.

12. The method of claim 11, further comprising confirming the internet connecting screen.

13. The method of claim 11, wherein the read data includes start time and information relating to a finish time of the selected program.

14. The method of claim 11, further comprising displaying a state of the reserved video recording.

15. The method of claim 11, wherein determining if reserved video recording is finished includes determining whether there is a key input to check if the reserved video recording is finished.

16. The method of claim 11, wherein the read data comprises broadcast program data that includes location information where a broadcasting program can be acquired and time information including start time and duration of the broadcasting program.

17. The method of claim 11, wherein reading the data comprises receiving data from the internet onto a terminal.

18. A video recording method comprising:
receiving broadcasting program information from the internet;
displaying the broadcasting program information on a display;
selecting a program to be video recorded based on the displayed broadcasting program information; and
receiving data from the internet based on the selected program.

19. The method of claim 18, wherein displaying the broadcasting program includes displaying an internet connecting screen.

20. The method of claim 19, further comprising confirming the internet connecting screen.

21. The method of claim 18, further comprising determining if reserved video recording is finished.

22. The method of claim 21, wherein determining if reserved video recording is finished includes determining whether there is a key input to check if the reserved video recording is finished.

23. The method of claim 18, wherein the received data includes start time and information relating to a finish time of the selected program.

24. The method of claim 18, further comprising displaying a state of the reserved video recording.

25. The method of claim 18, wherein the received data comprises broadcast program data that includes location information where a broadcasting program can be acquired and time information including start time and duration of the broadcasting program.

26. The method of claim 18, wherein receiving the data comprises receiving data from the internet onto a terminal.
